(19) United States
(12) Patent Application Publication
(10) Pub. No.: US 2010/0260663 A1
(43) Pub. Date: Oct. 14, 2010

(54) CARBON DIOXIDE FIXATION TO CARBONATES

(75) Inventor: Peter John O'Dowd, South Australia (AU)

Correspondence Address: CALFEE HALTER & GRISWOLD, LLP, 800 SUPERIOR AVENUE, SUITE 1400, CLEVELAND, OH, 44114, US

(73) Assignee: FORBES OIL AND GAS PTY, LTD., Tickera, S.A. (AU)

(21) Appl. No.: 12/679,762

(22) PCT Filed: Sep. 26, 2008
(86) PCT No.: PCT/AU2008/001444

§ 371 Date: Jun. 8, 2010

(30) Foreign Application Priority Data
Sep. 27, 2007 (AU) 2007905283

(51) Int. Cl. C01F 11/18; C01B 39/00

(52) U.S. Cl. 423/700; 423/417

(57) ABSTRACT

A high efficiency method or process is provided for converting CO₂ (carbon dioxide) to a mineralised compound. The method provides for the preparation of an aqueous solution of water and coal ash or coal residue which when contacted by CO₂ bind or convert the CO₂ into carbonates. The process can be carried out in in situ coal liquefaction mines. This process may be used to convert CO₂ in large quantities where the CO₂ is in concentrated volumes possibly sourced as a by-product from some process of industry. In another variation of the application of this process CO₂ may be directly captured from the atmosphere utilizing airflow over a contact surface or by spraying of one of the aqueous solutions of this process.

### FIELD OF INVENTION

This invention relates to methods of removal of carbon dioxide from the atmosphere or from industrial processes and more particularly to chemical absorption to remove and fix carbon dioxide from such sources.

### BACKGROUND OF THE INVENTION

The present invention is developed considering already known and existing problems of fixating or dissipating or disposing of carbon dioxide (CO₂).

A range of previous CO₂ management strategies have been suggested but few or none have been implemented because all existing CO₂ strategies fall short in one or more areas of technical efficiency or one or more areas of practical implementation.

For example CO₂ sequestration as a gas or liquid is often put forward as a solution to removing CO₂ from dissipation to the atmosphere.

However CO₂ sequestration has many shortcomings in practical application, not least of which is that the CO₂ remains in its primary form (gaseous or liquid) and so any potential escape from sequestration will result in the CO₂ dissipating into the atmosphere. It has been suggested that CO₂ could be sequestered into abandoned oil or gas wells. This suggestion fares poorly under most analysis primarily because if the abandoned well used does not contain an impervious cap rock the CO₂ will rise to the surface and dissipate into the atmosphere. Such an impervious cap rock is actually not at all common and even harder to quantify for total or only partial impermeability, and anything less than total impermeability will guarantee the CO₂ releases back into the atmosphere over time.

Furthermore the volumes of CO₂ needed to be sequestered for any commercial large scale application exceed by many times the volumes able to be contained in nearly any disused well.

Deeper sequestration can partially alleviate this problem as CO₂ generally condenses to liquid beyond approximately 4,000 feet below surface but then further problems arise. CO₂ has a broad triple point and phase change overlap will produce hydrate blockages to flow.

CO₂ is very corrosive to metals and is the cause of many metal failures and subsequent blowouts in the oil and gas industry, liquid CO₂ is even more intensely corrosive and substances for use as flow pipes and control valves in long term sequestration of CO₂ are not yet proven.

CO₂ can be and is used for miscible flooding in enhanced oil recovery. This, however, does not remove the CO₂ from dissipation into the atmosphere. In CO₂ flooding for enhanced oil recovery, the CO₂ is injected into the oil producing formation to mobilise residual oil and re-pressurise the oil formation, residual oil is then recovered to surface, and at that point the CO₂ must be stripped out from the oil and is either released to atmosphere or partially recycled to the process. Since very few if any of these oil formations would have impermeable cap rock formations the CO₂ will also be dissipating upwards though the soil throughout the oilfield until eventual escape into the atmosphere. CO₂ flooding of oil fields does not dispose or sequester CO₂, it merely introduces a commercial use and a partial delay before the CO₂ dissipates into the atmosphere. The large scale involved in CO₂ production and dissipation is one factor which has limited previous attempts of CO₂ dissipation.

One of the largest sources of world CO₂ emissions is coal fired power plants producing electricity. If we take a representative example of a 300 MW coal fired power plant as an example we can see some of the shortcomings of previously proposed methods of CO₂ dissipation. A 300 MW power plant at 35% efficiency (from coal in, to electricity to the busbar) emits 80 kg per second of CO₂ into the atmosphere. This typical power plant produces 2.32 tonnes of CO₂ per tonne of coal burned. This is 290 tonnes of CO₂ per hour, or 6,960 tonnes of CO₂ per day.

The USA utilities industry alone produces 2.1 billion tonnes of CO₂ per year.

Present suggestions for dissolution of this CO₂ centre around aqueous solutions of sodium hydroxide, most usually in conjunction with seawater, generally because of the large volumes of seawater available and also the fact that many power plants are sited with access to seawater to be used as a cooling utility in their process. If CO₂ from our 300 MW example power plant were to be dissipated by contact with a water solution containing sodium hydroxide with a calcium ion concentration of 400 grams per tonne then this would require an enormous volume of the sodium hydroxide/seawater. The flow of this sodium hydroxide/seawater through an above ground CO₂ process contactor vessel would be 18 million tonnes of seawater per day.

Furthermore the volume of solid mineral material produced is very large. This produces 666 tonnes per hour of CaCO₃ (calcium carbonate). This is almost 16,000 tonnes per day of solid carbonate produced. In any above ground process the physical handling and disposal of such large volumes of produced carbonate are a large disadvantage and are limiting factors.

It is the object of this invention to provide a useful method of carbon dioxide removal or at least provide a useful alternative method.

### BRIEF DESCRIPTION OF THE INVENTION

In one form the invention is said to reside in a method of fixing or binding carbon dioxide (CO₂) which fixates the CO₂ as a carbonate comprising the steps of; preparing an aqueous solution of water and coal ash or coal residue; contacting gas containing CO₂ with the aqueous solution; and reacting the CO₂ with the aqueous solution to produce a carbonate whereby the CO₂ is fixed or bound.

Preferably the aqueous solution includes 5% to 40% by weight coal ash or coal residue relative to water. The aqueous solution can further include one or more substances selected from the group comprising lime, dolomite or coal ash eluate.

The method can further include the step of contacting the gas containing CO₂ with the aqueous solution at an elevated pressure. The elevated pressure can be at least 2 atmospheres (30 psig).

The method can further include the step of contacting the gas containing CO₂ with the aqueous solution at an elevated temperature.

The step of contacting the gas containing CO₂ with the aqueous solution can be carried out in a depleted mine in which has occurred in situ liquefaction of coal, thereby depositing carbonate in the depleted mine.

The coal ash or coal residue can be provided from the in situ liquefaction of coal and water can be added to provide the aqueous solution water to provide almost total fixation of CO₂ gas contacted with the aqueous solution therein.

Preferably the pH of the aqueous solution is adjusted to be greater than 7.

The reaction of the CO₂ with the aqueous solution produces an exothermic reaction and further includes the step of generating steam or vapour in the course of fixating CO₂ which steam or vapour may be used as a source of energy to power machinery.

The reaction of the CO₂ with the aqueous solution produces a flow or redox reaction and further includes the steps of storing large amounts of electrical energy generated by the reaction as required and discharging large amounts of electrical energy as required.

In one form the step of reaction of the CO₂ with the aqueous solution can be carried out on a flow surface thereby absorbing CO₂ from air.

The invention can further comprise a method of manufacturing calcium carbonate which comprises a method of fixing or binding carbon dioxide (CO₂) which fixates the CO₂ as carbonate as discussed above.

The invention can further comprise a method of manufacturing zeolite type structures which comprises the method of preparing an aqueous solution of water and coal ash or coal residue, contacting gas containing CO₂ with the aqueous solution and reacting the CO₂ with the aqueous solution to produce a carbonate whereby the CO₂ is fixed or bound.

Hence it will be seen by the present invention that carbon dioxide (CO₂) may be either fixated as carbonate compounds in geological structures in the ground or may be fixated as a carbonate compound in air contact with the solution of this invention.

The present invention provides a low cost and high efficiency carbon dioxide fixation method which is effective through a wide range of applications.

### DISCUSSION OF PREFERRED EMBODIMENTS

The present invention fixates the CO₂ as a mineralised compound that may be adequately described as carbonate, by gas/liquid contact with the aqueous solution or solutions of the invention.

The present invention provides a useful application for coal ash, and at the same time control or fixation of CO₂ which would otherwise be released to the atmosphere. Moreover, the present invention provides a calcium carbonate manufacturing method using the fixation of CO₂ with the solution of this method. A portion of this carbonate so manufactured has a zeolite type of fine porous structure. This appears to occur with the presence of metallic oxides such as SiO₂, Al₂O₃, and Fe₂O₃, alkali metallic oxides such as Na₂O, and K₂O and alkali-earth metallic oxides such as CaO and MgO. In the reaction conditions of the present invention carbonate/zeolite type structures occur and these are useful and suitable for a variety of different purposes.

The solution of this invention in a preferred embodiment is primarily created by mixing coal ash with water. In addition to coal ash, either oxidised or de-coloured coal residue (such as the residue from in situ liquefaction of coal) or indeed any hydrocarbon ash residue may be mixed with water to create the basis of this solution. The oxidated de-coloured residue from in situ coal liquefaction may still be in situ in the ground in which circumstance the solution of this invention is created by mixing or flooding the in situ residue with water, if not already flooded with water. Coal ash or the residue from in situ liquefaction are the preferred additives to water. Further to the primary additives to water, lime or even dolomite may also be added to water either singly or in combination with any or all of the aforementioned additives to form the aqueous solution.

In this embodiment the CO₂ may be produced as a by-product of the coal liquefaction product and hence re-introduced into a depleted mine after separation of hydrocarbons and other valuable products or it may be from air with air being directed into the depleted mine to absorb CO₂ from the air before CO₂ depleted air is returned to the surface.

Usage of coal ash or any of the other additives including 10% weight or greater of CaO allows a higher Ca ion concentration in the absorbing solution thereby increasing the CO₂ fixation efficiency. Coal ash generally includes various sorts of metallic oxides. The type and amount of included metallic oxides can vary depending on the type of coal and even the individual formation of the coal. Metallic oxides such as SiO₂, Al₂O₃, and Fe₂O₃ are normally included. Alkali metallic oxides such as Na₂O, and K₂O and alkali-earth metallic oxides such as CaO and MgO are also normally included.

These metallic oxides and alkali-earth metallic oxides have a catalysing and reacting effect in the forming of CO₂ into carbonate compounds.

Fixating CO₂ using the solution of this invention in geological formations which may include sites of previous underground coal gasification or in situ liquefaction of coal such as depleted mines further takes advantage of the catalysing effect of these already present metallic oxides and alkali-earth metallic oxides by the added presence of further similar oxides in the geological formation.

For reasons of efficiency of CO₂ conversion it is preferable that the coal ash in the solution is between 4% and 40% by weight of the total solution, and as a guideline it is preferable that the CaO concentration be between 1% and 10% by weight relative to the entire slurry. Coal ash with a higher proportion of metallic oxides or alkali-earth metallic oxides, more specifically CaO, is preferable. Coal ash with a CaO content of 10% weight or preferably 20% weight makes it unnecessary to add a greater amount of coal ash or of lime or of dolomite in order to increase the calcium ion concentration in the water.

A strongly alkaline pH of the aqueous solution increases the CO₂ fixation into a mineralised compound. A pH of 10 is useful, however a pH of 12 or above is preferred.

At lower pH there is a tendency to dissolve rather than precipitate carbonates. Strongly caustic conditions favour rapid carbonate formation. CO₂ gas dissolves rapidly in water to produce a loosely hydrated aqueous form:

CO₂(gas)→CO₂(aqueous)

The aqueous CO₂ may then react with either water or, at high pH, with hydroxyl ions:

CO₂(aq)+H₂O→H₂CO₃

and this carbonic acid can dissociate as:

H₂CO₃→H⁺+HCO₃⁻

to give bicarbonate ions.

These reactions are favoured below a pH of 8.

Above a pH of 8 and particularly above a pH of 10 the reaction which predominates is:

CO₂(aq)+OH⁻→HCO₃⁻.

Once bicarbonate ions are present in the solution, carbonate ions can be produced by the following reaction:

HCO₃⁻→H+CO₃⁻⁻.

The carbonate ion then reacts with metal ions to produce insoluble carbonates such as calcium carbonate, magnesium carbonate and sodium carbonates. The preferred carbonate is calcium carbonate.

The high pH of the solution negates the normal rate controlling step which is the hydration of the CO₂, thereby the reaction(s) is(are) very rapid.

Of further benefit to the process is the uptake rate of CO₂ into the carbonate solution. A benefit of using coal ash as the base of the solution of this invention is the unexpected and novel uptake rate of CO₂ which the coal ash solution affords. The uptake rate of CO₂ into the solution is up to 9 times the rate of CO₂ uptake when bubbled through a vertical contactor without the coal ash of the present invention.

Further to this rate is the important fact that when using the coal ash solution all of the CO₂ is taken into the carbonate solution and will remain in solution without any significant de-gassing on exposure to the atmosphere. Increase over atmospheric pressure also enhances the efficiency of conversion of CO₂ into carbonate material.

Pressures of approximately 2 atmospheres (30 psig) are sufficient to enable virtually total conversion or binding of the CO₂ into carbonate material.

Atmospheric pressures give a total CO₂ conversion of 85% using this solution. These pressures of approximately 2 atmospheres (30 psig) are easily managed or achieved during conversion of CO₂ into carbonate compounds in geological formations using the solution of this invention. This pressure is beneficial to the practical application of the process as the pressure in the geological formation assists in preventing surface subsidence above the geological formation. This subsidence is a concern or difficulty during or subsequent to the underground gasification or mining of coal. Temperature increase above ambient temperatures also increases the efficiency of the fixation of CO₂ into carbonate compounds. The process of CO₂ fixation into carbonate compounds is also quite exothermic, that is heat is generated in the fixation process itself. This heat can be sufficient to generate steam or vapours in the geological formation especially if there are remaining traces or amounts of hydrocarbon in the geological formation which the CO₂ and the solution of this invention may interact with. This steam or vapours may additionally be used as a source of energy to power some form of machinery, for example a steam turbine.

The hydrocarbon and the CO₂ and the solution can interact to generate even more heat than would otherwise be generated without the hydrocarbon. This generation of heat and possible subsequent generation of steam or vapours can be sufficient to reach or exceed pressures of approximately 2 atmospheres (30 psig) without the need for any external source to provide the desired pressurisation of the geological formation. Lime added to water or to the aqueous solution of this invention will assist in fixating CO₂ and does in sufficient quantity raise the pH of the water to an alkaline state.

Dolomite added to water or to the aqueous solution of this invention will also assist in fixating CO₂ and does in sufficient quantity raise the pH of the water to an alkaline state.

Coal ash in the solution of this invention can fixate (approximately) 2.3 tonnes of CO₂ for every one tonne (approximately) of coal ash.

This appears to be a closing of a carbon cycle. The residue (coal ash) of a hydrocarbon which has released CO₂ during combustion appears to be able to fixate a similar amount of CO₂ when applied in the solution of this invention.

It can be seen that fixating CO₂ into carbonate compounds within geological formations using the solution of this invention in the ground negates the need of the enormous flow rates required by above ground process contactors and at the same time negates the need for the handling or disposal of large volumes of produced carbonate material.

When applied to fixating CO₂ in geological formations the solution of this invention is reused continually and may even be circulated continuously and is maintained in it's most effective range by addition of additional coal ash as CO₂ is fixated into carbonate; this carbonate, when formed, is already in its place of disposal, the geological formation.

If desired this carbonate can be recovered to the surface by more aggressive circulation of the solution of invention, in conjunction with surface separation of the carbonate solids from the solution.

A further application of the now carbonated solution in situ in the ground is as a storage device of energy or electrical potential. The solution in situ in a geological formation may now be employed as a flow or redox battery. That is in essence a large underground battery capable of storing large amounts of electrical energy, and as required discharging large amounts of electrical energy as required.

A flow or redox battery is typically an adjunct to solar or wind power generation. In periods of little sun or little wind electrical output to the grid can be maintained by drawing on the flow battery which has previously stored any excess of electrical production from the solar or wind array.

Air contact with the solution of this invention also negates the need for the huge volumes of water needed for above ground CO₂ process contactors. Likewise the amount of produced carbonate material is not of the same order of magnitude and so can more practically be collected and removed.

Air concentration of CO₂ is approximately 365 ppm (parts per million), pre-industrial revolution levels of CO₂ were approximately 250 ppm. While this concentration of CO₂ may seem impossibly small to deal with, the efficiency and scale of wind power actually translate air capture of CO₂ using the solution of this invention into a viable and important means of reducing global CO₂ concentrations.

Atmospheric dispersion of CO₂ is very rapid. CO₂ released anywhere in the world is fully dispersed in less than 12 months. The atmosphere can be thought of as a large efficient CO₂ transport system, equalising CO₂ released in one part of the world with the rest of the atmosphere. The atmosphere can also be thought of as a large, global CO₂ storage system.

These attributes mean that air capture of CO₂ can be employed in any location and still have a rapid global effect. Hence it is not necessary to locate CO₂ air capture devices at or even near the point of CO₂ emissions, nor is it necessary to entrap the CO₂ as it is released from a flue stack or chimney.

A suitably sized air contactor using the solution of this invention may be sited adjacent or nearby to the point of CO₂ emission, or it may be sited nowhere near the point of emission, even in another country and still effectively entrap CO₂ from the atmosphere in the same quantity as the original point of CO₂ emission. Air entrapment of CO₂ using the solution of this invention is a very effective process in terms of energy efficiency and is many orders of magnitude more efficient than either wind turbine power production or even solar power production when energy versus footprint size are considered.

For purposes of comparing efficiencies it is useful to translate the amount of CO₂ fixated by air contact with the solution of this invention, back into the heat or energy of combustion which originally generated the CO₂. At 365 ppm of CO₂ in air, one cubic metre of air (40 moles of air) contains 0.015 moles of CO₂. We can relate this amount of CO₂ to the amount of heat released by the combustion of gasoline (petrol) sufficient to produce the same 0.015 moles of CO₂. This heat of combustion equals 10,000 joules, thus removing CO₂ from one cubic metre of air is energy equivalent to the 10,000 joules of heat produced from combusting gasoline, anywhere in the world. It is important to note that the energy equation of CO₂ removal from air far exceeds the kinetic energy contained in air movement or wind itself.

Windmills for power (electricity) generation are becoming more prevalent. Windmills are rated by energy flux per unit area, a part of which windmills transfer into energy (electricity). Thus a windmill at wind speed of 10 m/sec would face an energy flux of 600 w/m², part of which would be turned into electrical energy. The equivalent CO₂ flux through the same area corresponds to 100,000 w for every square metre of air flow. By this measure of energy the removal of CO₂ from the air is far more concentrated than the kinetic energy harnessed by the windmill.

### EXAMPLE 1

### Underground Gasification Example

Underground gasification (pyrolysis) of a coal formation 100 metres underground has previously occurred. The coal formation is flooded with water above the level of the coal ash produced during the underground gasification of the coal formation and substantially in the proportions described above creating the aqueous solution suitable for the present invention. This solution may preferably be flowing, that is pumped in a continuous loop throughout the geological formation.

CO₂ gas or air containing CO₂ is injected into the aqueous solution and on contact the CO₂ is fixated to the ions in solution creating a mineralised compound which may be described as calcium carbonate. As the CO₂ is fixated into carbonate the pH of the solution drops. Additional coal ash, perhaps sourced from a coal fired power plant, can then be added to the solution to continue absorbing more CO₂. Additional lime or dolomite may also be added to elevate the pH of the solution to preferred levels.

This process of fixating CO₂ into carbonate and then refreshing the solution of this invention with further coal ash and possibly lime or dolomite as required allows further fixation of CO₂. This enables large quantities of CO₂ to be fixated while using only modest amounts of water due to the continued reuse of solution and also allows for the economical storage of the produced carbonate within the geological formation.

The quantity of CO₂ fixated by this method may be measured by the volume of CO₂ flow into the geological formation as the fixation of CO₂ is essentially total.

### EXAMPLE 2

### Air Capture Example

A free standing structure to support an air contact with the solution suitable for this invention may be constructed. More simply existing buildings or structures may be employed to support a contact area between the air and the solution of this invention. The contact area may consist of but is not limited to any porous or permeable surface capable of adhering the solution to it while enabling air contact with the solution. The produced carbonate may be periodically removed from the contact surface by some physical means for collection or disposal or the contact area may itself be renewed or replaced. A non-porous contact area may also be employed by having that non porous surface perforated so as to allow air contact with the solution through the perforations, or by employing the forces of hydroscopic adhesion to adhere the solution to a non porous surface and so provide air contact. Again the carbonate may be periodically removed from the contact area or the contact area itself may be renewed or replaced.

Another application can include any mechanism which allows air contact with the solution of this invention in some manner in which the solution is free from contact with anything other than air, such as a mist of the solution which air may pass through. The quantity of CO₂ fixated by such methods may be measured or calculated by the volume of the carbonate created with regard to the strength of the solution and or the volume of solution consumed.

The invention described herein has been described in Australian Provisional Patent Specification No: 2007905283 entitled “Carbon Dioxide Fixation to Carbonates” and the teachings therein are incorporated herein in their entirety. The underground gasification (pyrolysis) of a coal formation has been described in Australian Provisional Patent Specification No: 2008903845 entitled “Method for In Situ Liquefaction of Coal” and the teachings therein are incorporated herein in their entirety. Jet pumps suitable for assisting in the in situ liquefaction of coal are described in Australian Provisional Patent Specification No: 2008903840 Entitled “Inventive Jet Pumping” and the teachings therein are incorporated herein in their entirety. Throughout this specification various indications have been given as to the scope of this invention but the invention is not limited to any one of these but may reside in two or more of these combined together. The examples are given for illustration only and not for limitation.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

1. A method of fixing or binding carbon dioxide (CO₂) which fixates the CO₂ as carbonate comprising the steps of;
preparing an aqueous solution of water and coal ash or coal residue;
contacting gas containing CO₂ with the aqueous solution; and
reacting the CO₂ with the aqueous solution to produce a carbonate whereby the CO₂ is fixed or bound.

2. The method according to claim 1 wherein the aqueous solution includes 5% to 40% by weight coal ash or coal residue relative to water.

3. The method according to claim 1 wherein the aqueous solution further includes one or more compounds selected from the group comprising lime, dolomite or coal ash eluate.

4. The method according to claim 1 further including the step of contacting the gas containing CO₂ with the aqueous solution at an elevated pressure.

5. The method according to claim 4 wherein the elevated pressure is at least 2 atmospheres (30 prig).

6. The method according to claim 1 further including the step of contacting the gas containing CO₂ with the aqueous solution at an elevated temperature.

7. The method according to claim 1 wherein the step of contacting the gas containing CO₂ with the aqueous solution is carried out in a depleted mine in which has occurred in situ liquefaction of coal, thereby depositing the carbonate in the depleted mine.

8. The method according to claim 1 wherein the coal ash or coal residue is provided from the in situ liquefaction of coal and water is added to provide the aqueous solution to provide almost total fixation of CO₂ gas contacted with the aqueous solution therein.

9. The method according to claim 1 wherein the pH of the aqueous solution is adjusted to be greater than 7.

10. The method according to claim 1 wherein the step of reaction of the CO₂ with the aqueous solution produces an exothermic reaction and further includes the step of generating steam or vapour in the course of fixating CO₂ which steam or vapour may be used as a source of energy to power machinery.

11. The method according to claim 1 wherein the step of reaction of the CO₂ with the aqueous solution produces a flow or redox reaction and further includes the steps of storing large amounts of electrical energy generated by the reaction as required and discharging large amounts of electrical energy as required.

12. The method according to claim 1 wherein the step of reaction of the CO₂ with the aqueous solution is carried out on a flow surface thereby absorbing CO₂ from air.

13. The method according to claim 1 wherein the step of reaction of the CO₂ with the aqueous solution is carried out by spraying the solution into air thereby absorbing CO₂ from air.

14. A method of manufacturing calcium carbonate which comprises the method of claim 1.

15. A method of manufacturing zeolite type structures which comprises the method of claim 1.
